(19) United States
(12) Patent Application Publication
(10) Pub. No.: US 2006/0080082 A1
(43) Pub. Date: Apr. 13, 2006

(54) System and method for product migration in multiple languages

(75) Inventors: Vinjamuri Venkata Ravindra, Bangalore (IN); Vinjamuri Venkata Narasimha Rao, Bangalore (IN); Ramadevi Krishnan, Bangalore (IN)

Correspondence Address: BIRCH STEWART KOLASCH & BIRCH, PO BOX 747, FALLS CHURCH, VA, 22040-0747, US

(73) Assignee: Geneva Software Technologies Limited, Bangalore (IN)

(21) Appl. No.: 11/208,518

(22) Filed: Aug. 23, 2005

Related U.S. Application Data
(60) Provisional application No. 60/603,288, filed on Aug. 23, 2004.
(60) Provisional application No. 60/603,629, filed on Aug. 24, 2004.

(51) Int. Cl. G06F 17/20

(52) U.S. Cl. 704/8; 704/1

(57) ABSTRACT

The system and method of the present invention provides for product migration in multiple languages without effecting any change to basic configuration of the source application system. The system comprises user interface, database member to store need-based application modules, migration enabling components, languages, address locations having character and/or character modifier profile generating executables and transformation engine; a product migrating processor to enable migration of the source application into the target application; a memory device and an display member to display the migrated application. Initially a source application is input and a target language is selected. Then selection and execution of need-based applications corresponding to the selected source application is performed. Then product migration of source application into target application is carried out by implementing migration enabling components and the migrated product is rendered on which transformation is performed to finally display the migrated target application at the display member.

The present application claims priority under 35 U.S.C. § 119(e) of U.S. Provisional application 60/603,288 & 60/603,629 filed Aug. 23, 2004 & Aug. 24, 2004; respectively, the entire contents of which are hereby incorporated by reference.

### TECHNICAL FIELD

The present invention relates to a system and method for product migration in multiple languages. The system and method of the present invention relates to product migration in multiple languages without effecting any change to basic configuration of the source application system. The system and method of the present invention particularly relates to migration of a source application from its source language to a target language by providing an inherent architectural configuration to handle the elements of source application including extract product information module, extract general features module, extract business logic module, extract data services module and presentation layer module.

### BACKGROUND AND PRIOR ART

In the present day technology relating to migration of product from one language to another, the emphasis is more towards “Textual Translation” with different levels of accuracy. Product localization is a prevailing concept, which is a small component of Product Migration. Existing models are largely confined to “Services/Solutions”. Some of limitations of such a model are viz., conversion from one language is an intrinsic one, which means the source application has to be screened/changed at the code level. Further, the architecture of the product needs to be changed, resulting in substantial expenditure in terms of engineering effort, time and operational cost. In addition, the time to market factor is high and the converted application needs to have additional unit, integration and performance tests.

U.S. Pat. No. 6,507,812 describes a method of mock translation by use of extra characters for each field (user interface element). The invention also provides a method to visually inspect the possibilities of truncation of words etc. This invention does not have any Layout Manager which will address the placement, size and wrapping of International language text with different screen layouts and layouts are not managed dynamically in real sense.

U.S. Pat. No. 6,507,812 describes a method of mock translation by use of extra characters for each field (user interface element). The invention also provides a method to visually inspect the possibilities of truncation of words etc. This invention does not have any Layout Manager which will address the placement, size and wrapping of International language text with different screen layouts and layouts are not managed dynamically in real sense. U.S. Pat. No. 6,233,545 U.S. Pat. No. 6,760,695 U.S. Pat. No. 6,278,967 U.S. Pat. No. 5,761,631, U.S. Pat. No. 6,275,789 describe document translation.

U.S. Pat. No. 6,389,386 describes a method, system and computer program product for sorting text strings is described. The invention also provides a method, system and computer program product for sorting text strings in a culturally correct order where the text string language does not provide pronunciation information and/or data processing system character codes are unsorted for the text string language. This invention deals primarily with data sorting for Non-English languages and does not use Unicode for sorting.

U.S. Pat. No. 6,161,083 describes an Example based translation method and system dealing with the process of translating a sentence by breaking into words and applying different analysis.

### OBJECTS OF THE PRESENT INVENTION

The main object of the present invention is to provide a system and method for product migration in multiple languages without effecting any change to basic configuration, including the source code, of the source application system.

An object of the present invention is to provide a system and method of product migration into multiple languages that is adaptable and scalable to any existing system. Another object of the present invention is to provide a system and method for product migration in multiple languages by seamlessly integrating server, middle and client components.

Yet another object of the present invention is to provide a system and method for product migration in multiple languages that works across different Operating System Platforms, Programming Languages and Application Software.

Further object of the present invention is to provide a system and method for product migration in multiple languages that can store multilingual data in the same database with rapid inter-conversion

Yet another object of the present invention is to provide a system and method for implementing sorting and spell-check of the desired language.

### SUMMARY OF THE INVENTION

The present invention provides a system and method for product migration in multiple languages. The system and method of the present invention provides for product migration in multiple languages without effecting any change to basic configuration of the source application system the system for migrating source application into a multiple-language target applications comprises a user interface to input source application data and select target application language; a database member disposed to store plurality of need-based application modules, migration enabling components, languages, address locations having character and/or character modifier profile generating executables and a transformation engine; a product migrating processor to enable migration of the source application into the target application by implementing migration enabling components; a memory device to provide a temporary dynamic storage for the input source application and work area for product migration and an display member to display the migrated application. The product migrating processor forms character and/or character modifier and invoke the transformation engine corresponding to the resultant character and/or character modifier and source application from the database member and perform transformation and to render the resultant migrated product. Initially a source application is input and a target language is selected. After the selection a system check process is initiated to identify the type of operating system and operating system specific modules are executed. Then the source application is read and the availability of Unicode or non-Unicode compatibility is checked. Further selection and execution of need-based applications corresponding to the selected source application is performed. Then product migration of source application into target application is carried out by implementing migration enabling components and the migrated product is rendered. After rendering the transformation is carried out on the migrated and rendered product and finally the final target application is displayed at the display member.

### BRIEF DESCRIPTION OF THE DIAGRAMS

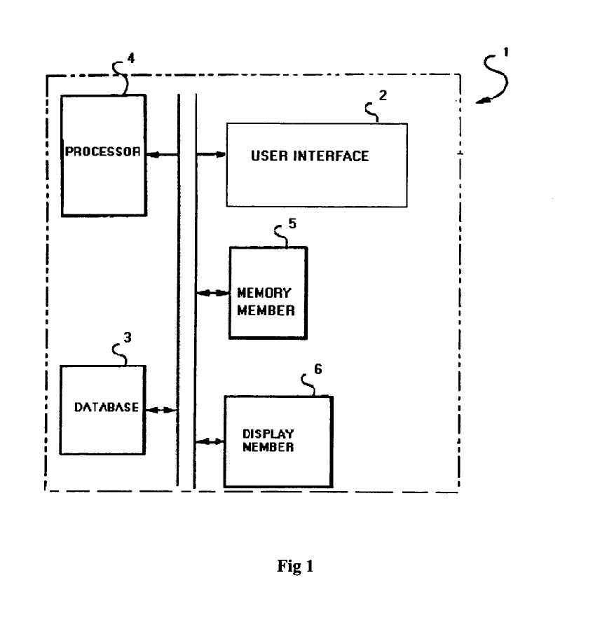

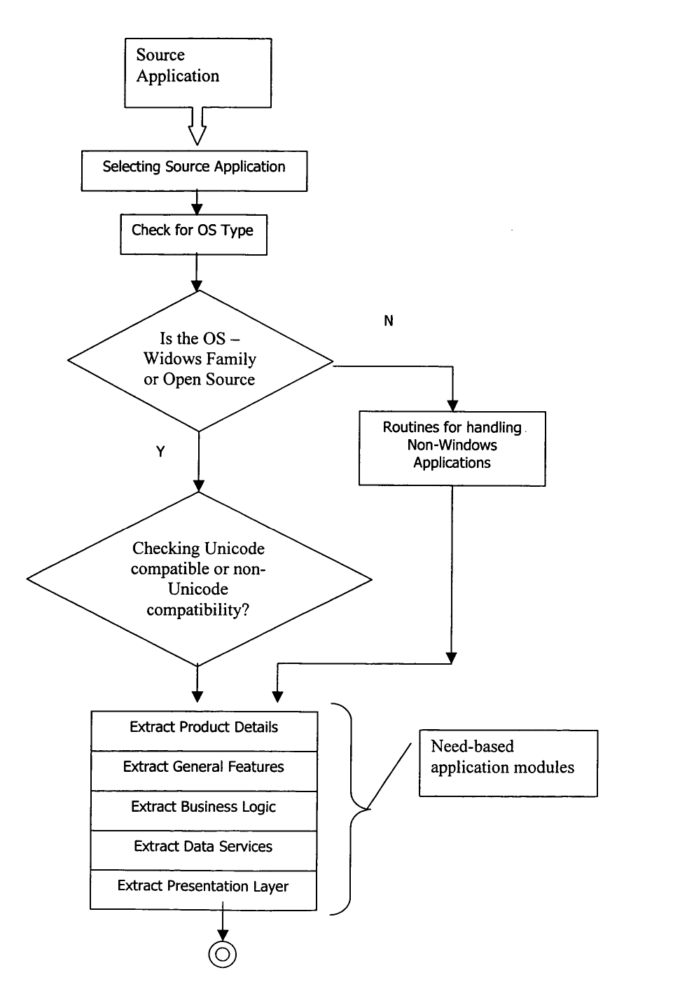

FIG. 1 depicts the block diagram of the system of the present invention.

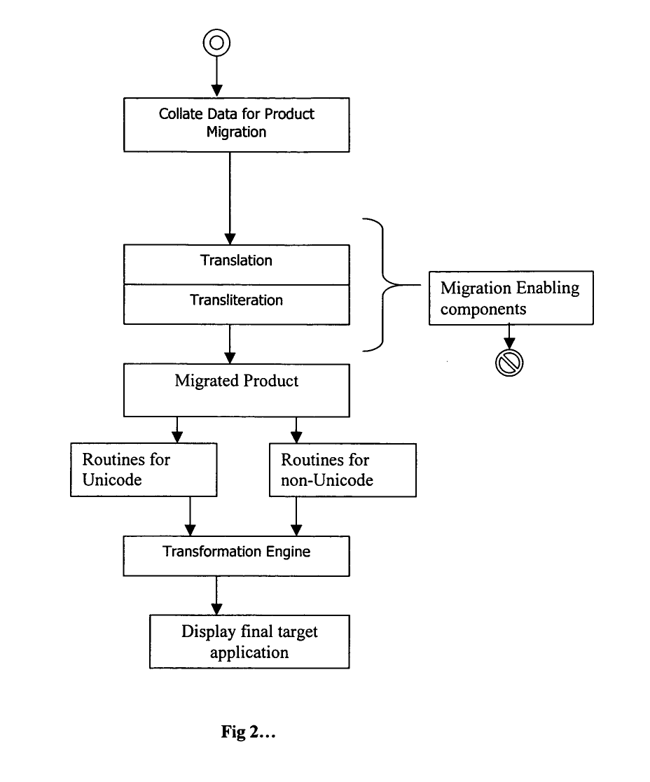

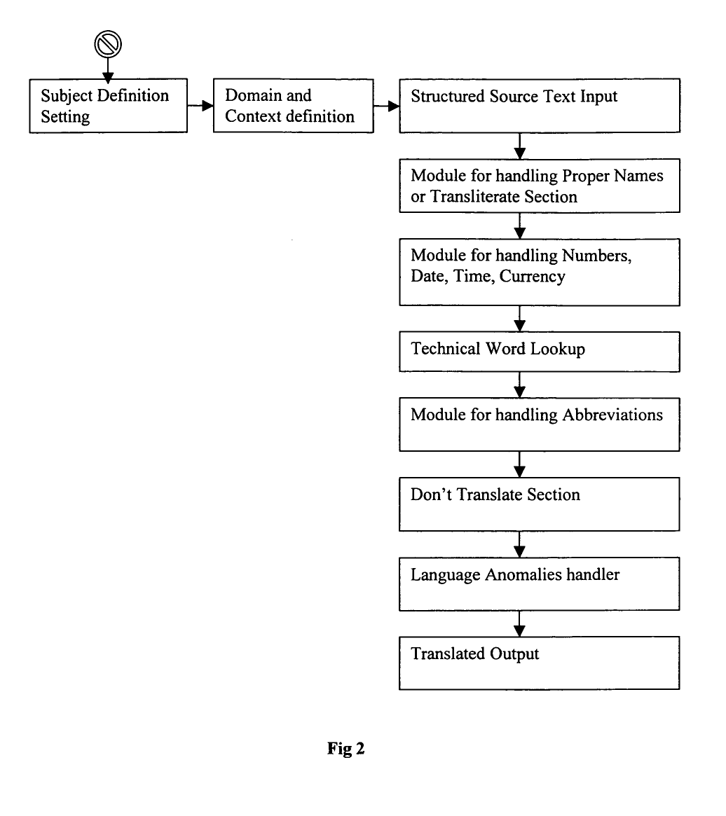

FIG. 2 depicts the flow diagram of the method of the present invention

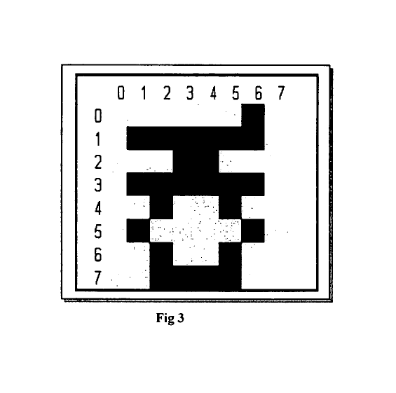

FIG. 3 depicts the depicts a character matrix for a character in Kannada Language (An Indian language)

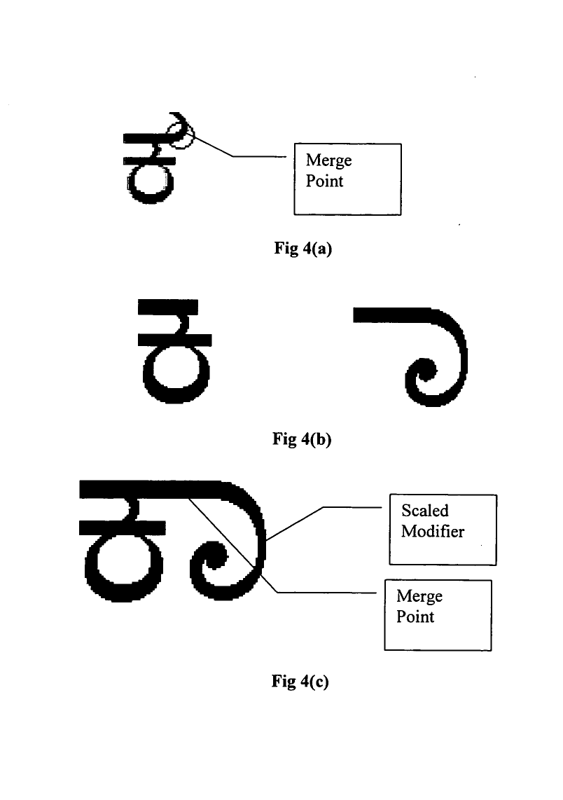

FIG. 4 (a), (b) & (c) depict various stages involved in the formation of character matrix from a combination of single character and a character modifier.

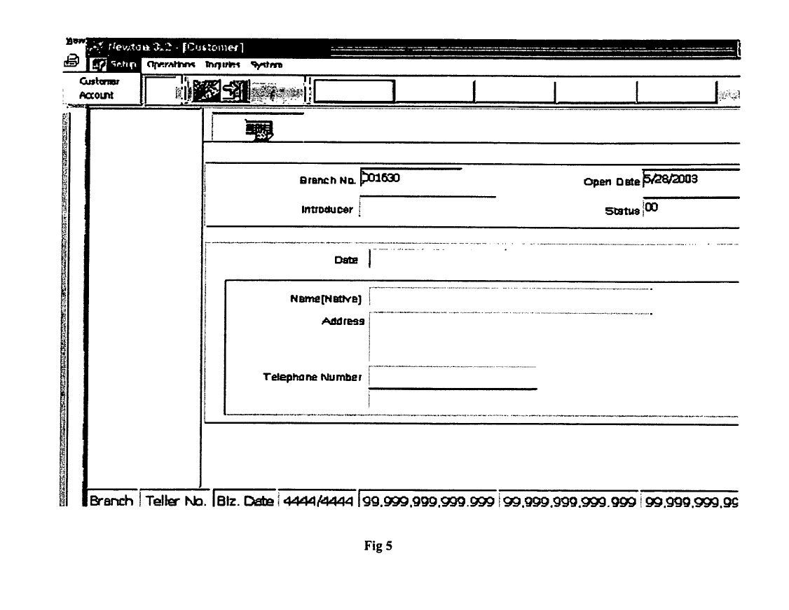

FIG. 5 depicts a banking source application with top level menu as well as sub-menus.

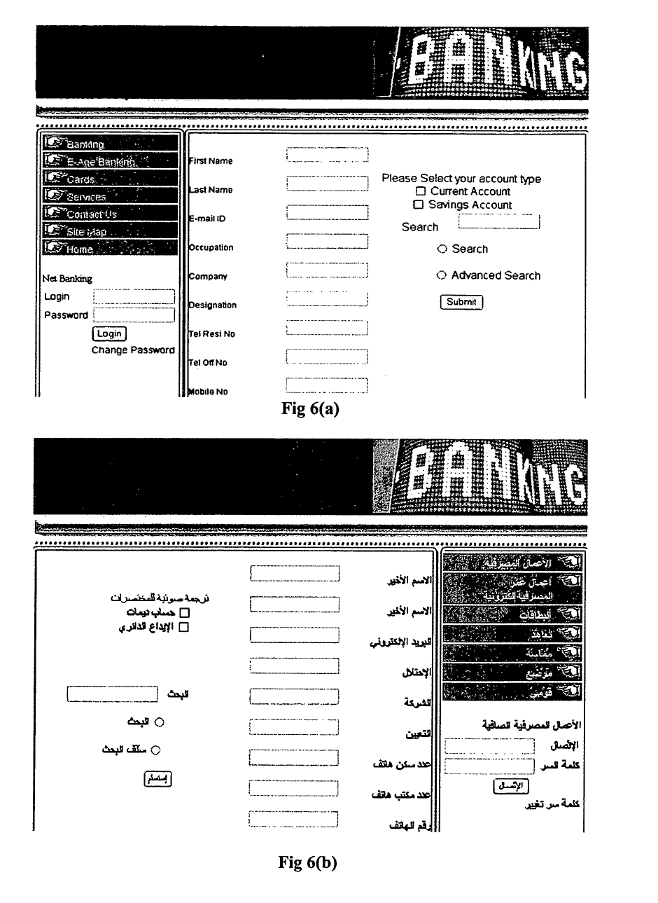

FIG. 6 (a) & (b) depicts a sample Banking Application in English language and the output in the form of a migrated product in Arabic language.

### DETAILED DESCRIPTION OF THE INVENTION

The system and the method of the present invention comprise a product migration engine which can be integrated to any known data network systems. Data network systems primarily comprise Server, Middle layer and Client components. The product migration engine of the present invention is either a server-based or client-based.

The basic components of the system of the present invention are depicted in FIG. 1 of the accompanied diagrams. The system (1) of the present invention, for migrating source application into multiple-language target applications, is operable in networking environments to convert the source application into multiple languages without effecting any change to basic configuration of the source application system. The system and method of the present invention particularly relates to migration of a source application from its source language to a target language by providing an inherent architectural configuration to handle the elements of source application including extract product information module, extract general features module, extract business logic module, extract data services module and presentation layer module.

The system (1) of the present invention for migrating source application into a multiple-language target applications comprises, an user interface (2) as a means to input source application data and to select target application language. The user interface (2) may be selected from a keyboard, a touch screen or a stylus input from a PC/Server, keypad input or stylus input, from a PDA and keypad input or stylus input from a cellular phone.

A database member (3) is disposed to store a plurality of need-based application modules to permit selection of the required modules. The database member (3) is also disposed to store migration enabling components to cause migration from source to target application. These migrating enabling components are encapsulated or categorized as translating and transliterating executables. The database member (3) additionally stores languages, address locations having character and/or character modifier profile generating executables and a transformation engine.

The need-based application modules depend on the type of source application and includes five different modules which are, extract product information module, extract general features module, extract business logic module, extract data services module and presentation layer module.

A product migrating processor (4) acts as a means to enable migration of source application into target application by implementing migration enabling components. This product migrating processor (4) is disposed to invoke the transformation engine corresponding to the resultant character and/or character modifier and also the transformation engine corresponding to the source application from the database member (3). The product migrating processor (4) is also disposed to execute the transformation engine and display the resultant migrated product.

The processor (4) which is used to migration of the source application of the present invention, is generally a microprocessor or a series of microprocessors Intel Series-80486, Pentium-I, II, III, IV, Centrino, AMD Series complete range, Xeon, XSCALE Series, MCORE, Motorola chipset, Nokia chipset, ARM Series etc, that are suitable for product migrating applications in digital computers and cellular devices.

A memory member (5) is disposed in the system (1) of the present invention, to provide a temporary dynamic storage for the input source application and also provide a work area for product migration. The memory member (5) selected for the system of the present invention is a memory member that is generally used in implementing applications of this nature in digital machines, such as RAM or Cache memory.

An display member (6) is used to enable the user to select the options that he desires. The display member (6) also displays the final migrated product. The display member (6) of the present invention is selected from output devices such as a digital LCD (Liquid Crystal Display), PDA and VDU (Visual Display Unit).

Now by referring to FIG. 2, the method of the present invention for migrating the source application into multiple language target application, is explained by means of a flow diagram of the schema of the present invention. The user initially selects the source application which has to be migrated to another language. The user then selects the target language to which the source application has to be migrated to. For example the source application may be in the English language and the user desires that the source application be converted to Chinese, then in such a case, the target language that the user selects will be Chinese. When the source application is selected, the vital information about the application and the path for accessing the application is procured. Then the inputted source application is stored in the memory member (5). The migration application of the system of the present invention is given the top priority and is run as an independent entity under the operating system. In other words the migration application of the present invention is running on top of all other applications of the operating system. That is the migration application of the present invention is indexed as the first application running on the operating system. This signifies that any application which is run later than the migration application of the present invention will be given lower priority. Thus the migration application of the present invention can select the source application as if it were a part of itself. Once the source application is stored in the memory member, the product migrating processor (4) reads the physical address and size (memory occupied by application) of the application from the memory member (5). Then the operating system handler is obtained. The operating system provides a unique ID (which is alpha-numeric) to the source application (in fact to every application run on it), every time it is executed. This ID is dynamically generated and is called as the operating system handler. The source application is accessed using this ID. After this a buffer object of the read application is created and then it is associated to the operating system handler. After this step, the created buffer object is set as a global object (in other words source application) and the different parameters of the global object are computed. The different parameters of the global object or the source application are; position of the application (x1, y1), window size of the application (x2, y2), memory size occupied by the application, cache size and the number of child windows (in other words dialog boxes, sub-windows, etc).

Once the source application is selected and the source application is placed in the memory member (5), a system check process is initiated to identify the type of operating system the source application is running on. Every operating system has a unique method of handling the memory allocation or re-allocation process. This is also called as cache level memory management. In operating systems like Windows, most of the application memory requirements are automatically managed by the operating system itself. However, in certain operating systems like Linux, etc., the application does not automatically manage the memory. In such operating systems, the application makes a manual call to the operating system interface and the user has to manually allocate the memory for different applications. In case the operating system used is such that the memory allocation process is automatically managed, additional routines need not be called. However, in cases where the operating system is such that the memory allocation has to be performed manually, operating system specific modules have to be executed for handling source applications run on such operating systems. Some operating system specific routines that have to be executed include, display driver access routines, advanced memory management routines, CPU optimization routines or advanced peripheral device control routines. These routines are executed because the operating system by itself does not give optimum results for running the source application. Hence, when the above specific routines are executed, it will be realized as to how to procure optimum benefit of the existing system parameters such as memory, processor speed, etc. Then the source application which is present in the memory member (5) is actually read and the different components of the source application are noted.

After this the source application is verified for the availability of Unicode or non-Unicode compatibility. An application is said to be Unicode compatible if its text elements (localization elements) conform to the Universal System of Language Addressing. An application is said to be Unicode compatible if a certain set of parameters of the application are Unicode compatible. The parameters are, language settings as defined in the Standard Unicode Specifications, resource standardization and source code standards. In resource standardization all the user interface elements like menus, buttons etc are verified to be Unicode compatible or not. In case of source code standardization the use of resource bundles is verified to be Unicode compatible. The resource bundles in case of source codes are tabbed files which store strings with corresponding resource ID, for example 001, “Login” etc. In case an application is Unicode compatible, it has to satisfy all the above parameters for Unicode compatibility.

The system of the present invention is also provided with an additional internal mechanism to verify the Unicode compatibility of the source application which is selected. In order to achieve this, the following tests are carried out. A request is sent to the source application for its version information. Version information is a general information which is commonly available with any application. In case the response to this request is in ASCII format of 1.1 (for this example we are considering the version to be 1.1, however the same may be applicable for any version), then the application is said to be supporting only ASCII and can be concluded that it is not Unicode compatible. However, in case the response to the version request is in the form of UTF-8 of 1.1 which will be shown as U0031, U002E, U0031, then we can easily conclude that the source application is Unicode compatible.

Another verification test that is carried out is, a request is sent to the source application to procure information about the presence of a resource module. A resource module contains details of the source application such as window frame name, label name, dropdown box, command button etc. An example of this resource file is provided below. For instance in case of a banking source application the first window or screen would be a login window as shown below.

[image]

The resource module for this window of the source application will contain the following details.

| ID | Type | Value |
|---|---|---|
| 001 | Window Frame | Login |
| 002 | Label | Choose Language |
| 003 | Combo Box (Dropdown) | English, Arabic, Chinese |
| 004 | Command Button | OK |
| 005 | Command Button | Exit |

In case this resource module is present then it can be concluded that the source application is Unicode compatible, and in case this module is absent then it can be concluded that the source application is non-Unicode compatible.

In case the source application satisfies the above-mentioned verification tests, it is concludes that the source application is Unicode compatible. Once the source application is determined to be Unicode compatible or non-Unicode compatible, the product migrating processor (4) selects the need-based application module corresponding to the source selected source application. The need-based application modules depend on the type of the source application and include product extract information module, general feature extract information module, business logic extract module, data services extract module and presentation layer module.

The components that are included within product extract information module are business functions component, product architecture component which obtains the front end details (in case of the above example of banking application it is Java Server Pages), backend databases (in case of the above example of banking application it is SQL Server) and Webserver (in case of the above example of banking application it is Apache Tomcat); an operating system version extract component which sends a request to the operating system to identify the version of the operating system (in case of the above example of banking application the version is Windows XP 5.1.2600); a window count extract component extracts the number of window screens of the application (in case of banking application the total number of window screens of the application is four), a report count extract component indicates the total number of reports of the application (in case of above example of banking application the total number of reports is 1) and a java libraries extract component which requests for libraries in use by the source application (in case of banking application it is Java Email API).

The business functions component of the product extract information module include reading of all the menu items of the source and ignoring the general functions like File functions namely, New, Open, Save, etc, Edit functions like Undo, Cut, Copy, Paste, etc. While reading the menu items of the source, in case of a source application like Banking application, the following may be the top level main menu items, Setup Menu within which there will be Customer information sub-menu and Account information sub-menu, Operations menu within which there will be Deposit information sub-menu, Inquiries information menu within which there will be Transaction History information sub-menu and finally System Menu within which there will be Exit sub-menu. From the above list, the actual business function components are Customer information, account information, deposits information, inquiries information and transaction history information. It may be noted here that the system menu with exit is not a business function component and is treated as a command only.

An example of the business functions component is shown with the help of a window of a banking source application in FIG. 5. In FIG. 5, a banking source application is shown with top level menu items like setup, operations, inquiries and system. In addition to the main menu items, sub-menus of the setup main menu are also displayed.

The general features module includes procedures to extract different version of a language like Chinese. Since there are many versions of Chinese like Central Chinese, simplified Chinese etc. NLF checks to see the variants of a language. The variants exist with respect to geography etc. In this case the variants are Simplified Chinese, Central Chinese. The general features module also decides when the Locale settings should be loaded, build-time, install-time, at startup, when client connects, when user changes settings, etc. In the case of banking applications, the locale settings should be loaded at the start of the application.

The components that are included within general features extract information module are classification of windows component which determines the total number of admin windows and the total number of user windows; a localization help component which checks whether localization help is required, this localization help is required if there are a large number of business components (in case of banking application localization help is required) and finally a cultural data component which takes care of the cultural data that are involved in different source applications. The cultural data component further includes, time-date-calendar sub-component, numerical sub-component, currency sub-component, three-letter currency code sub-component and sorting sub-component.

The time-date-calendar sub-component checks if the application needs time, date and calendar format to be available in different languages. The numerical sub-component checks if the application requires numbers to be displayed in the locale-specific format, in case of banking applications it is required. The currency sub-component checks if the application needs currency symbol to be displayed in the locale-specific format, in case of banking applications it is required. The three-letter currency code sub-component checks if the application needs use of International three-letter currency code to be displayed in the locale-specific format. For example, the three-letter currency code INR is used for Indian Rupees and USD is used for US Dollars. In case of banking applications this is required. Finally the sorting sub-component checks if the application needs sorting, in case of banking application this is required.

The components that are included within business logic extract module are international data component, concatenation of text component, common text component, data handling component, multi-byte character systems component, third party component, time zones component, inter locale character component, input method editor (IME) interface component and translatable component. The translatable component further includes, run-time translatable sub-component, message catalog sub-component and non-message sub-component.

In case of business logic extract module, the processor sends a request to the source application for each of the sub-components that are included in the business logic extract module, in case the response returned is yes, then the component is executed else it is not-executed.

In the international data component a request is sent to find out if there is ability to process international text and data (input/output), in concatenation of text component request is send to find out whether concatenation of text and/or UI elements been removed, in common text component request is sent to find out all text in centrally located resources, in data handling component request is sent for fully separated languages specific—Data Handling Logic (DHL) from the business logic, in multi-byte character systems component request is sent to ascertain if there is a mechanism to process Multi-byte Character Systems (MBCS) correctly, in third party component request is sent for requirement of any third party components that may require language layer for example printers, etc, in time zones component request is sent for data referring to different time zones and to have a means to unify all these, in inter locale character component request is sent to extract flag for accepting characters from other locales, in input method editor (IME) interface component request is sent for extracting flag for proper input methods and implementing the Input Method Editor (IME) interface.

The translatable component of the business logic extract information component includes run-time translatable sub-component requests for the translatable contents to be loaded correctly at runtime, the message catalog sub-component requests for the messages being extracted from the product into message catalogs, the message catalog sub-component also requests for the messages to be installed in locale-specific directories, the message catalog sub-component also checks whether the correct default message appears for the messages which have not been provided for a locale and finally a non-message sub-component requests to find whether all non-message textual objects reside in locale-specific directories.

The components that are included within data services extract module are database storage component which requests for defined architecture in the database for storage of multi-byte dynamic and static data; performance factor component requests for performance factor of storage and processing of multi-byte data in the database; data transfer component requests to handle non-English data from the browser to database and then back without data loss; encoding component requests for ability for encoding of a file and database configuration component requests to handle all the non-English languages that the source application may need to support.

The components that are included within presentation layer module which determines methods of handling the Output Screens are, client side component to send request for inputting language text, input validation component to send request for client side input validation, UI adaptation component to send request for UI adaptation to higher resolutions than 800×800 pixels, image version component to extract flag for different version of static images and icons for different language settings, style sheets component flag for style sheets for presenting different language contents (Style sheets are templates for web applications), prompts component to extract flag for client side prompts and message dialogs to be in specific language, e-forms component, regional UI component flag for cultural & regional issues for the UI, consistent terminology component, grammar component flag to request grammatical correct, white space component to request for sufficient white space, culture specific component to ensure cultural specific elements been identified and located in replaceable modules (clipart, sound, video), visual component to ensure that visual elements and cultural references been removed from the UI, printing component for display and printing of text using the appropriate fonts and char sets, text expansion component, internationalization component to ensure if all messages in the GUI correctly internationalized, resizing component to ensure whether the resizing of the GUI works correctly, personalization component to ensure if GUI personalization can be saved by the user and whether these are configurations in locale-specific directories, locale component to ensure if the GUI positions are not provided for a locale and whether the product use default positions and positions component.

When the need-based applications corresponding to the source application are selected and the corresponding components and/or sub-components are executed, the results of the need-based applications are stored and collated in the form of a text file. When the need-based applications are executed, the results obtained are either in the form of a Yes or No or stored in the form of checking of a flag. These results are collated and stored in the form of a text file. A sample source application is considered in the form of a banking application and after execution of the need-based applications, the following data collation is performed and stored in the form of a text file for further processing.

The window screen data is
Admin=1
User=3
1:0,0,200,100
2:0,0,800,600
3:0,0,800,600
4:0,0,800,600

The list of Translatable components are as follows:
Login Page, Choose Language, English, Chinese, Ok, Exit
Main Page: Setup, Customer, Account, Operations, Inquires, System
Customer Page: Branch No., Open Date, Introducer, Status, Date, Name(Native), Address, Telephone Name
Account Page: Branch No., Teller, Product Code, Currency, New Account No., Introducer, Last Tx. Date, Balance, Close Date, Status, Open Date, Payable Interest.

The Transliteratable components are as follows:
Login, Branch, Teller No., Biz. Date,

The Transformation Parameters are as follows:
LangID=Arabic(SA)
R2L=1
Right_Padding=15
Top_Padding=20
Complete_Transform=Yes
Mixed_Allowed=Yes

And the Display Parameters are as follows:
RT_CURSOR=1
RT_BITMAP=2
RT_ICON=3
RT_MENU=4
RT_DIALOG 5
RT_STRING=6
RT_FONTDIR=7
RT_FONT=8
RT_ACCELERATOR=9
RT_RCDATA=10
RT_MESSAGETABLE=11
RT_GROUP_CURSOR=RT_CURSOR+11
RT_GROUP_ICON=RT_ICON+11
RT_VERSION=16
RT_DLGINCLUDE=17
RT_PLUGPLAY=19
RT_VXD=20
RT_ANICURSOR=21
RT_ANIICON=22
RT_HTML=23

The above collated data which is stored in the form of a text file is provided to the product migrating processor (4). The product migration is performed by the product migrating processor by using the above collated data by means of executing the migration enabling components. The migration enabling components are encapsulated or categorized as translating executables and transliterating executables and are stored in the database member (3) of the system of the present invention. The migration enabling components of the present invention uses a multi-step process for performing the migration (translation or transliteration) of a word, phrase and a sentence of a source application in a source language to a target application in a target language. The steps of the above process are explained with the help of a flow diagram as depicted in FIG. 2.

The first step in the above process for performing product migration of a source application into a target application is categorizing the source application into a particular category of application which will define the subject of the translation. This is facilitated by the results that are obtained after executing the need-based application. Accordingly the source application is categorized into a particular subject, like Banking application (including finance, securities and insurance), business application, legal application, medical application, information technology, mythology, etc. This step of categorizing the application into a particular subject is very essential as it defines a large set of parameters for Translation in selected subject. This step is the configuration setting and is performed during the first run of the system.

The next step is in configuring the Domain & Context setting which determines the Topic or the sub level of the subject of the source application. Since the subject of the source application has already selected in the previous step, this step actually narrows down the scope of the subject. For instance, from the above subjects, a domain or context of banking can be Retail Banking or net banking etc. In this step the narrower context helps in further fining the translation module. In the above banking application the context can be selected from different contexts or domains such as, “Retail Banking Software Product Description”, “Retail Banking Help System”, “Retail Banking moratorium procedures” etc.

Once the subject of the source application and the domain within that subject is defined, the structure of the text input of the source application is categorized accordingly. The structure of the text input of the source application is dependent on the Subject, Domain and Context of the source application. For instance, while considering a source application as business applications and the domain within that as Business Email. We see that during the drafting of the e-mail the body of the email begins by addressing the recipient such as

Dear Client
Dear Colleague
Dear Customer
Dear Friend
Dear Madam
Dear Sir
Dear Sir/Madam
Hello

The next information in the e-mail body would be the Date.

[image]

Depending on the parameters, the possible sub phrases or sentences that may be entered in the e-mail body would be selected from one of the phrases shown below.

[image]

In any source application, there would be some words like names of people which should not be translated but should be transliterated, to perform this task the second migrating enabling component is executed which performs the phonetic conversion of a word as per the language rules. This is very much necessary for converting proper nouns which should not be translated as per their meaning.

For instance, the name “Ravi” if translated means “Sun”. But for practical purpose it should only be transliterated in all languages. The processor of the present invention is provided with an intelligence to find equivalent sounds in each language and tune the translated word accordingly. For instance in Chinese, the nearest sound for “wa” is “wei”. So, the phonetic equivalent of “Ravi” in Chinese should be “Rawei”

[symbol]

The next step that is carried out is to execute the migration for numbers, currency, date and time. Here the translation of the numerals, date, currency and time is done to the specific languages while considering the data and information of that language. For example, when migrating numbers in Chinese general Indo-Arabic numerals are used, but for specifying the year Chinese language is used. Similarly the conversion is performed of all numerals, date, time and currency which are displayed in the source application. Additionally, a quick Word look-up table is provided which can be accessed by the User and the processor internally. Most of the finite and combinational words of a particular Subject, Domain and Context are stored in the form a look-up table for ease in retrieving. For instance based on a letter “C”, the possible words in case of business applications could be “Cash, Cash on Delivery, Cash Box” etc.

The next step that is performed is in application of routines to handle popular abbreviations like T.V, U.S etc into the appropriate languages. This also includes some slang words like “hru” to indicate “How are you” and “lol” to indicate “Laugh Out Loud”.

In the source application, there will be certain words like company names, etc. which should not be translated or transliterated. The migrating enabling components recognize these words and it will not perform translation or transliteration of these words and print them as they are in the Source language.

The migration module of the present invention also performs the task of language anomaly handling. Sometimes the same thing can be worded in many different ways, for example in case the source application is information technology, the phrase “computer monitor” or “video display unit” can be simply be termed as “Screen”. These kind of word anomalies are also handled by the migrating enabling component. Finally after performing all the above steps, the finally migrated product is stored in the memory member (5) for further processing. This migrated product that is stored in the memory member is the translated and transliterated output of the source application which can be displayed at the display member (6).

Before the migrated source application is displayed at the display member, rendering of the migrated source application is performed. The rendering of the source application is carried out in different manner depending on whether the application is Unicode compatible or non-Unicode compatible.

In case the source application selected is Unicode compatible, the rendering of the source application is performed by means of mapping. The first step in this mapping is to initially set the Unicode range for the target language. Unicode has a starting and ending address for every language as prescribed Unicode specifications. For example in case of Chinese language, the starting address of Chinese language is U+4E02, which is shown below. The first letter in the Chinese language is [symbol] then all the other characters of the Chinese language follow in order.

[image]

It may be noted that the above table is only a partial representation of the characters of the Chinese language.

Similarly, in case of Arabic language the starting address is U+067E, which is shown below. The first letter in the Arabic language is [symbol] then all the other characters of the Arabic language follow in order.

[image]

It may be noted that the above table is only a partial representation of the characters of the Arabic language.

The next step in this Unicode compatible routine is to read the resource module of the source application which is already available. Each of the values that are stored in the resource module is then converted to equivalent Unicode compatible characters. For example in the above mentioned banking application, the resource module of the first window which is depicted below, here the Unicode equivalent for each of the values is determined and stored. For instance the Unicode equivalent of “Login” in Latin (English) is, U+004C, U+006F, U+0067, U−0069, U+006E. The above method of mapping is carried out for each and every character of the source application, and finally the entire source application appears in the target language. This final rendered target application is stored in the memory member.

[image]

In case the source application is non-Unicode compatible, then direct mapping of the character of the source application cannot be carried out by initially setting the Unicode range for the target language. This is because the source application itself is not compatible with Unicode standards. In such a case, mapping of the characters of the source application with equivalent address locations stored in the database member (3) is performed. The mapping arrangement in the present invention is a conventional one that is prevalent in any digital processing systems. The address location of each character of the Unicode compatible languages is stored in the database member (3). These address locations are present for each and every character of each and every Unicode compatible languages. The address locations stored in the database member (3) comprise corresponding character profile generating executables. When the characters of the source application are mapped with the corresponding address locations in the database member, the processor secures the corresponding character generating executables from the mapped address location. The secured character generating executables are stored in the memory member (5) by the processor (4). Once the character generating executable for the desired character of the source application is stored in the memory member (5), the product migrating processor (4) finally executes the character generating executables to generate a pixel sequence which is associated with the shape of the selected character. The generated pixel sequence is then stored in the memory member (5).

The functional steps of the character generating executables are as follows:
I. Reading Screen Resolution from environment settings
II. Picking up appropriate character matrix ratio, where matrix ratio depends on output unit. For instance, if the dots per inch (dpi) are 72 then pick 24×24 matrix ratio for the character.
III. Starting Global counter or character positioning counter ‘g’ with an initial value equal to 1, where “1” is the left coordinates of the output unit
IV. Starting Outer loop counter or pixel column counter from 0 to 23 (columns)
V. Starting inner loop counter or pixel row counter from 0 to 23 (rows)
VI. Reading row value and plot appropriate dots (pixels)
VII. Incrementing row counter value by 1
VIII. Ending the loop end-row
IX. Incrementing pixel column counter by 1
X. Ending the loop end-columns
XI. Incrementing global counter with the value of the width of the letter i.e., 24+space of 2

The character-generating executable takes the address location of the character as a pointer and the corresponding values for generating the character are computed.

The main parameters for computation are the environment settings, which include screen resolution in terms or the dots per inch and the extents of the screen expressed as “x” and “y” pixel values. Like 640×480, 1024×768. The pixel sequence that is generated is stored in the form of a matrix. The character matrix ratio is appropriately chosen from 12×12, 16×16, 24×24, etc. For environments like the PDA or Mobile, the display system will be unique or proprietary to OEMs (Original Equipment Manufacturers). The ratio of the matrix will be chosen as 17×24 etc.

Once these parameters are in place, the character-generating executable begins with a global counter, which stores the cursor position relative to the width of the character. Initially this counter is set to the leftmost position of the display member. The display left position is the x-axis position of the first available pixel on a display. Next the counters for incrementing the rows and columns are started. The initial values will be ‘0’ for both and the ending limit will be the ratio value (like 23 for a 24×24 ratio). The row value is read from the string expression, which returns the pixels to be darkened (whose value is to be set for ‘1’). Each element of the row is incremented until the last pixel of the row limit is reached. The row counter governs this. When the first row is complete, the column counter is incremented by ‘1’; the routine is repeated for all the rows until the column limit is attained. After the character is fully formed, the global counter is updated with the width of the formed letter and additional count of 2 is added to provide the placeholder for the cursor.

The output will be returned as a string with pixel information for a 12×12, 16×16 or a 24×24 ratio matrix.

After the address of a character to be formed is computed, then the executable to be applied is for the character formation. The executable compute the following:

Character Base Height:

Depending on the platform like a PC (Personal Computer), PDA (Personal Digital Assistant) or Cellular Phone, the minimum size of Indian language letter will be about 14 to 18 points depending on the language.

For a resolution of 79×81 dots per inch, the width is about 10 pixels and the character height is about 14 pixels

The higher the dots per inch the number of corresponding pixels will be more. For instance, in a PC environment, the difference in Picture quality on a 640×480 pixels and 800×600 pixels is because of the size of the pixel. Higher the resolutions smaller will be the pixel size

This setting is automatically calculated by the layout manager depending on the environment and display settings.

Character Matrix Ratio:

Based on the display settings and permissible client width of an environment the character matrix ratio has to be adjusted. Client width signifies the space available for the program to draw on the screen.

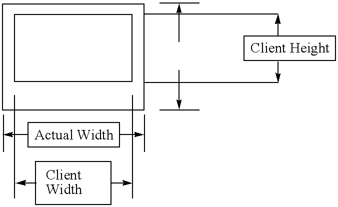

The above figure shows the display of a typical cellular phone. The Client area will be smaller than the actual area of the display. This is the first factor of measurement. The second factor of measurement is the availability of “number of lines” and “number of characters per line”. On a typical cellular phone, 3-5 lines are supported with about 20 characters per line. This will be smaller for older phones and for the advanced phones the number of lines will extend. However in this case the Standard SMS (Short Messaging Service) protocol limits the message width to 160 characters. However, it may be noted here that the example of cellular phone is considered only for ease in explanation and the same can be applicable to PC, Servers, laptops etc. Based on these parameters, the character matrix is calculated. The possible combinations are:
12×12
16×16
24×24
17×24

All the values are in pixels

Actual Character Data

The actual data about a character is stored in the form of a character-generating executable. The matrix is generated when the character is selected by the user and the address location for that character is secured and the data in the address location, which basically is a character generating executable to that character, is finally executed. A typical pixelized matrix representation of a character will be in the ratio as described above. A depiction of the matrix for the character [symbol] which is a character from Kanada language, (which is a South Indian language) is shown in FIG. 3.

In FIG. 3, the digital areas of matrix of a character to be displayed are categorized into display and non-display areas. The displayed pixels are marked as dots, which carry the pixel information as “1” and non-displayed pixels are blank are null or “0” respectively. This matrix is read by appropriate functions and the output is sent to the Operating System specific display member (6). The result is the display of the character on the PC Screen or a PDA or on a Cellular Phone as an Image.

Once the character image is generated as specified above, display of the character is performed in conjunction with Unicode Standards (UTF-8).

In order to illustrate the formation of the pixel sequence, we consider an exemplary embodiment. For instance, if the pixel sequence has to be generated for a character

[symbol]

The pixel sequence generation formation detail for the above character is represented below in the form of Binary data or HEX data.

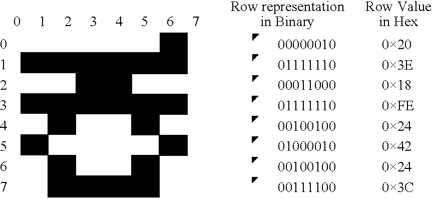

The above figure represents the pixel sequence generation details of the above character.

The ratio formation is 8×8 pixels.

In order to generate the above pixel sequence, the following steps are adopted:
a. Reading screen resolution from environment settings
b. Picking up appropriate character matrix ratio, where matrix ratio depends on output unit. For instance, consider 8×8 matrix ratio for the character.
c. Starting Global counter ‘g’ with an initial value equal to 1, where “1” is the left coordinates of the output unit
d. Starting Outer loop counter from 0 to 7 (columns)
e. Starting inner loop counter from 0 to 7 (rows)
f. Reading row value and plot appropriate dots (pixels)
g. Incrementing row by 1
h. Ending loop-row
i. Incrementing column by 1
j. Ending loop end-columns
k. Incrementing global counter with the value of the width of the letter i.e., 8+space of 2 (determined by transformation engine)

Some of the important stages of the formation of the above pixelized image are provided below:

Filling of the pixels begins in Row-1 and continues till the end of the Row. The formed picture would look as below: 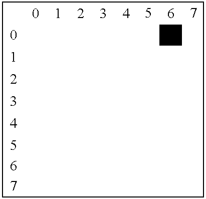
Stage-2

Filling of the pixels begins in Row-2 and continues till the end of the Row. The formed picture would look as below: 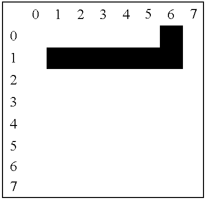
Stage-3

Filling of the pixels begins in Row-5 and continues till the end of the Row. The formed picture would look as below: 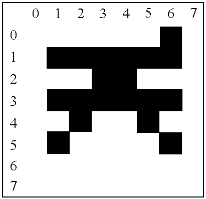
Stage-4

Filling of the pixels begins in Row-6 and continues till the end of the Row. The formed picture would look as below: 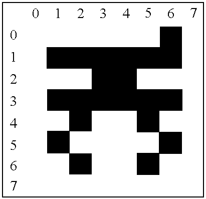
Stage-5

Filling of the pixels begins in Row-7 and continues till the end of the Row. The formed picture would look as below:

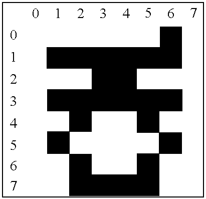

This is the completed pixel sequence of the character

[symbol]

The generated pixel sequence is associated with the shape of the character and/or character modifier from the database member (3).

The formation of character modifiers and their linking to the selected character is explained by referring to FIG. 4.

In the present invention, the desired modifiers are welded to the characters before merger and display. For instance, if a single character is keyed the same is displayed on the display member (6). However, if the user desires to add character-modifiers to the above displayed character, a suitable key of a modifier is depressed to generate the desired character-modifier at the display member (6) and said modifier is positioned at a pre-determined place near placed the selected character. The placement of the character-modifier is decided in accordance with the transformation engine stored in the database member (3). Once the character and the character-modifiers are placed close to each other, the modifiers are combined or merged to form a single unit.

After the generation of the pixel sequence by the processor (4), the generated pixel sequence is stored in the memory member (2a). The processor (4) then invokes the transformation engine corresponding to the resultant character from the database member (5). The transformation is divided into three main tasks, which are scaling height and width of character to be displayed, fusing or merging the scaled character with the scaled modifier and also determining the space between any two resultant characters.

The transformation engine then finally executes the transformation that was invoked from the database member. During the process of execution of the transformation, initially the scaling of the height and the width of the generated pixel sequence of the character is performed. For determining the scale height and width of the pixel sequence of the character, the recorded data, which was initially stored in the memory during the power-on of the system, is used. Accordingly, the scaling of the height and the width of the desired character is performed as per the dimensions of the display member (4) of the system as well as considering the dots per inch or resolution of the display member (4).

In case the user desires to have a character modifier also in addition to the character already selected, then the above steps of selection of the desired character modifier, fetching of appropriate address location, shifting the address of address location to memory, securing and executing the corresponding character modifier profile generating executables, invoking and executing the transformation, are repeated again for the character modifier.

When the user also selects a character modifier, the scaling step of transformation also involves adjustment of the height and width of the character modifier. The character and the character modifier are scaled or trimmed to the extent required. The different steps involved in scaling and merging of the character and character modifier are depicted in FIG. 4. Once the character and the character modifier are scaled to the desired requirement, then scaled character and scaled character modifier are merged together at the merge point, as depicted in FIG. 4.

In another embodiment of present invention, the dynamic rendering of characters does not depend upon the fonts or Unicode. This dynamic rendering of characters is achieved by use of character profile generating executables to create the language characters dynamically. Dynamic rendering uses the mechanism of pixels, strokes, glyphs to produce the shape of the characters on the display member (4).

The process of merging of character-modifiers with the character is depicted in the form of following examples.

### EXAMPLE 1

The steps involved in the merging process of the character [symbol] of the Kannada language is graphically represented as follows:

[image]

### EXAMPLE 2

In this example, a combination of character modifier with the corresponding character and their respective address locations are shown. On depression of consonant, the consonant is displayed and thereafter the desired character modifier is selected. The character and character modifier are merged to form a resultant character along with fused modifiers.

[symbol]

The phonetic representations of the above Indian characters are provided in English for easier understanding.
k+A=kA

Next, the second key depression produces the vowel sign. The results of this example are depicted in FIG. 4. As seen from FIG. 4, the vowel sign is placed next to the consonant, the necessary scaling of the second character will be handled by the transformation engine. Transformation engine stored in the database member (3) provides the scaling of data for formation of resultant character with fused character modifiers. Scaling of character and character-modifier is performed by scaling few columns of character matrix and few columns of a character-modifier matrix, this scaling done according data available in the transformation engine and according to the type of character and modifier combination. After the scaling, the merging of the scaled character and character-modifier to form a resultant character with fused character modifiers takes place. FIG. 4(c) shows the final resultant character with fused modifier.

In an embodiment of the present invention, the process of merging of individual glyphs to form a single entity reduces the total number of glyphs to nearly 50%. The space adjustment as performed in the present invention is exemplified in the following example. In this example, a word from Kannada language is chosen to show the space adjustment and hyphenation.

### EXAMPLE 3

The processor invokes the transformation engine, which determines the spacing between any two resultant characters along with their fused modifiers. The transformation engine, also determines the spacing within each individual character, wherever applicable (especially for Indian languages).

Finally, after the resultant character is formed along with the merged modifier, the same is displayed on the display member of the system of the present invention.

[image]

An example of character formation and display in Chinese language by using the method and system of the present invention is exemplified in the following example.

### EXAMPLE 4

This example is to illustrate the merging process used in Chinese Language. The original character is depicted as (i) and the character after the process of merging is depicted as (ii):

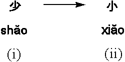

Now again considering the above-mentioned example of the banking application as the source application, in the first window which is a login window (as shown below for convenience), the title “Choosing language” which is visible has to be translated to a target language. On applying the non-Unicode compatible mapping and rendering process described above for Arabic language, the result obtained is [symbol] which is the Arabic equivalent of “Choosing Language”.

[image]

The above steps of rendering are carried out for each and every character of the source application, and finally the entire source application appears in the target language. This final rendered target application is stored in the memory member.

It may be noted here that by using the above two methods of rendering of an application i.e., either Unicode compatible mapping method or non-unicode compatible rendering method, the end result is the same, that is a migrated and rendered target application. The method of rendering only facilitates to render the application even if it is non-Unicode compatible.

The final migrated and rendered target application is stored in the memory member before being displayed in the display member. The transformation engine stored in the database member performs the task of final transformation of the target application before display.

This transformation engine assembles the migrated product based on the and performs calculations based on the Source and Target Screen Resolutions, computes Font Sizes, compute white space between controls, perform calculations based on general layouts of operating system windows, performs Internationalization functions for User Interface elements like Command Buttons, Labels, Text Area etc, performs flip for right to left languages like Arabic. After the transformation engine is run, the target application assumes its final shape and is displayed at the display member as a final target application in the target language. A knowledge base is maintained in the database member for handling different cultures of the World. For instance, in China, Yellow background and Red Foreground colors are preferred. Similarly, In UAE, Green background is preferred. The transformation engine, depending on the target language and subject will select appropriate colors and backgrounds thus personalizing the final display output.

The system for product migration is capable of migrating any User Interface, Data Services or Internationalization functions by utilizing the same product migration engine. The product migration achieved by the system of the present invention is instant. The product migration feature of the system of the present invention has applications in the fields of Banking, Finance, Securities, Insurance, Manufacturing, Telecom, Health Care and Automotive Industries. This multiple applicability is possible due to the engine of the present system being compatible at the Server-side, Middle layer as well as the Client side. The product migration achieved by the present invention does not interfere with the source code of the applications being migrated and operates external. The system of the present can be implemented in any data and telecommunication networks.

The system and method of the present invention additionally provides a sorting means for advanced sorting in different languages for the source application. The sorting module is applicable to any language foreign or Indian language. However, as an exemplary embodiment, sorting in Indian languages is performed based on the Varnamala (Varnamala is the standard arrangement of letters in a language. The Varnamala for Kannada language, a regional south Indian language of India is depicted below:

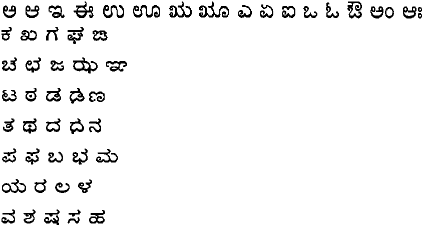

The characters or glyphs shown in the Varnamala set above can be combined as shown below:

[symbol]

[symbol]

[symbol]

The working of the sorting module of the system of the present invention is shown below in the form of Table 1. The table shows a sample input text consisting of 8 different words in Kannada language (An Indian language) to be sorted. A comparative account of total count of characters in word of Kannada language with the word count performed under the present invention is provided in Table 1. A reduction in the number of character count can be seen from the Column 4 of Table 1, as result of welding of individual characters and character-modifiers to form a whole-character, thereby reducing the total number of characters to about 50%. The column 5 of Table 1 provides a sorted order for the desired language.

TABLE 1

| | Input | No. Of | No. of | |
|---|---|---|---|---|
| SI | Text | glyphs | glyphs | Sorted Order |
| 1 | 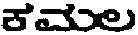 | 5 | 3 | 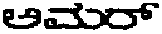 |
| 2 | 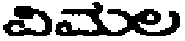 | 4 | 3 | 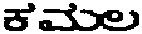 |
| 3 | 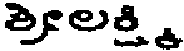 | 7 | 3 | 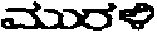 |
| 4 | 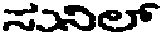 | 6 | 3 | 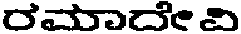 |
| 5 | 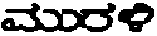 | 6 | 3 | 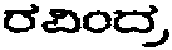 |
| 6 | 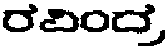 | 7 | 4 | 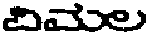 |
| 7 | 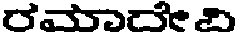 | 9 | 4 | 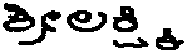 |
| 8 | 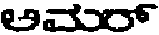 | 5 | 3 | 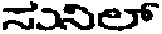 |
| Total | | 49 | 26 | |

The sorting means of the present invention reduces the time required to sort and increases the efficiency in handling the sorting process. Sorting of Text according to a language is accomplished by arranging the words in the order of the respective language's alphabet

One of the methods of sorting in Chinese is using GB 2312 (GB=Guojia Biaozhun “National Standard”) coding of Unicode. This is one form of numbering the Chinese character. GB 2312 (1980) includes 6,763 Chinese characters (on two levels: the first is arranged by reading, the second by radical then number of strokes), along with symbols and punctuation, Japanese kana, the Greek and Cyrillic alphabets, Zhuyin, and two sets of Pinyin letters with tone marks (full-width and half-width). The chart below shows a partial list of characters in the sorting order.

[image]

The system and method of the present invention additionally provides an efficient Spell-Check module. In the spell-check module a source string or word to be spell-checked is compared to a standard dictionary and a set of rules are applied. The first step is to verify if a perfect match is found, in case a perfect match is found at the step of comparison the same is displayed and if the match is not found then alternatives are suggested. The spell-check module also provides a facility for the user to manually correct the word. In the system of the present invention, the number of iterations is drastically reduced to improve the performance of the spell-check module of the system. A standard procedure is used to check the spellings of both the Input and Output Strings (Text). For the source text like English, a standard dictionary of at least 1 million words is necessary. The same applies to Chinese and Arabic languages. The spell check is performed in the following steps, initially the word is read, then the word is categorized according to the grammar of that language like Noun, Pronoun, Verb etc while ignoring the proper nouns, the abbreviations are then ignored, and the capitalized words (applies to English) are completely ignored, in case a word is found then the same is associated with a tag, which can be used by the migration enabling components, in case the word is not found then tag called “Transliterate” so that migration enabling component will convert to the phonetic equivalent of the same in the target language.

### EXAMPLE 5

A sample banking source application in English is depicted in FIG. 6(a). Here the application is desired to be converted into a target language which is Arabic. On the above source application the product migration is performed and finally the migrated target application is shown in FIG. 6(b).

Advantages

1. The system and the method of the present invention support Enterprise Applications, PDAs and Mobile applications.
2. The system and method of the present invention supports product migration in all World languages including Chinese, Japanese Korean (CJK); Right to Left Languages like Arabic, Hebrew, Farsi; Latin/Roman Script like French, German, Italian, Spanish etc; Indian Languages including registered Indian languages and rare languages like Pali etc.
3. The system and method of the present invention provides an ultimate mechanism to take business to the Global Market by conveniently migration their Software Products/Websites/Web Applications to different languages.
4. The output rendering means of the present invention is provided with an intelligent means to perform either translation or transliteration of the source application.
5. The system and method of the present invention provides product migration for all modules of an application like Business Functions, Presentation, Reports, Data Services, etc
6. The system and method of the present invention provides 100% scalability and integration support for all proprietary and open source operating systems as well as Programming Languages.
7. The system and method of the present invention has a universal database for all available languages with intelligent inter-language conversion mechanism and cultural information of every nationality.
8. The system and method of the present invention complies with internationally accepted Unicode standard.

We claim:

1. A system for migrating source application into a multiple-language target applications, said system comprising:
(a) a user interface as a means to input source application data and to select target application language,
(b) a database member disposed to store plurality of need-based application modules,
(c) said database member disposed to store migration enabling components to cause migration from source to target application,
(d) said database member disposed to store languages, address locations having character and/or character modifier profile generating executables and a transformation engine,
(e) a product migrating processor means to enable migration of the source application into the target application by implementing migration enabling components,
(f) said product migrating processor disposed to form character and/or character modifier,
(g) said product migrating processor disposed to invoke the transformation engine corresponding to the resultant character and/or character modifier and source application from the database member,
(h) said processor disposed to perform transformation and to render the resultant migrated product,
(i) a memory device to provide a temporary dynamic storage for the input source application and work area for product migration, and
(j) a display member to display the migrated application.

2. The system according to claim 1, wherein the user interface is selected from a keyboard, a touch screen or a stylus input from a PC/Server, keypad input or stylus input from a PDA, keypad input or a stylus input from a cellular phone.

3. The system according to claim 1, wherein the display member is selected from LCD, PDA and VDU.

4. The system as claimed in claim 1, wherein the need-based application modules depend on the type of source application, said need-based applications comprising,
(a) product extract information module consisting of business functions component, product architecture component, an operating system version extract component, a window count extract component, a report count extract component and a java libraries extract component,
(b) general feature extract information module consisting of classification of windows component, a localization help component and finally a cultural data component,
i. said cultural data component consisting of, time-date-calendar sub-component, numerical sub-component, currency sub-component, three-letter currency code sub-component and sorting sub-component,
(c) business logic extract module consisting of international data component, concatenation of text component, common text component, data handling component, multi-byte character systems component, third party component, time zones component, inter locale character component, input method editor (IME) interface component and translatable component;
i. said translatable component consisting of, run-time translatable sub-component, message catalog sub-component and non-message sub-component,
(d) data services extract module consisting of database storage component, performance factor component, data transfer component, encoding component and database configuration component and
(e) presentation layer module consisting of client side component, input validation component, UI adaptation component, image version component, style sheets component, prompts component, e-forms component, regional UI component flag, consistent terminology component, grammar component, white space component, culture specific component, visual component, printing component, text expansion component, internationalization component, resizing component, personalization component, locale component

5. A method for migrating source application into a multiple-language target applications, said method comprising the steps of:
(a) inputting a source application,
(b) selecting a target application language from a plurality of languages,
(c) storing the source application in a memory member,
(d) initiating a system check process to identify the type of operating system,
(e) executing operating system specific modules,
(f) reading the source application,
(g) checking for the availability of Unicode or non-Unicode compatibility,
(h) selecting and executing need-based applications corresponding to the selected source application,
(i) performing product migration of source application into target application by means of implementing migration enabling components to form a migrated product,
(j) rendering of the migrated product,
(k) performing transformation on the rendered product, and
(l) displaying the final target application at the display member.

6. The method as claimed in claim 5, wherein the rendering of migrated product is carried out by a method of rendering of multi-lingual characters from a combination of pixels; said method comprising steps of,
(a) choosing a character and/or character modifier from the source application to be rendered,
(b) fetching an appropriate address of the address location for said character and/or character modifier by mapping from the database member, said address location comprising corresponding character and/or character modifier profile generating executables,
(c) shifting the address of the selected address location to a memory member,
(d) securing the corresponding character and/or character modifier profile generating executables from said address location, into the memory member, by a product migrating processor, and
(e) generating a pixel sequence, which is associated with the shape of the character and/or character modifier and storing the same in the memory member.

7. The method according to claim 6, wherein the generating of pixel sequence having a desired character width and height, said method comprising the steps of:
(a) reading display resolution from environment settings,
(b) picking up appropriate character matrix ratio for the selected display member,
(c) initializing a character positioning counter with an initial value of “1”, where “1” is the left-most coordinate of the selected display member,
(d) initializing the pixel column counter with “0”,
(e) initializing the pixel row counter with “0”,
(f) reading the row and column values iteratively and plotting appropriate pixel to form a pixelized character matrix till the terminal row and column counters equal to “n”, and incrementing the value of pixel column and row counters by 1, and
(g) incrementing the character positioning counter after the formation of a single character and/or modifier by a pre-determined value and generating the final form of character derived from pixel matrix.

8. The method according to claim 5, wherein said transformation comprising the steps of:
(a) scaling the height and width of the character and character modifier as per dimensions and dots per inch of display,
(b) fusing or merging the scaled character with the scaled character modifier at the points of scaling, to form the resultant character along with the fused modifier, and
(c) determining spacing between any two resultant characters and spacing within each individual character, wherever applicable.
